(19) United States
(12) Patent Application Publication
(10) Pub. No.: US 2008/0148311 A1
(43) Pub. Date: Jun. 19, 2008

(54) Advertising and content management systems and methods

(76) Inventor: Steven N. Tischer, Atlanta, GA (US)

Correspondence Address: SCOTT P. ZIMMERMAN, PLLC, PO BOX 3822, CARY, NC, 27519, US

(21) Appl. No.: 11/638,609

(22) Filed: Dec. 13, 2006

(51) Int. Cl. H04N 7/10

(52) U.S. Cl. 725/32

(57) ABSTRACT

Methods, systems, and products are disclosed for replacing an advertisement. The advertisement is categorized as overrideable, meaning the advertisement may be replaced with another advertisement. A request is received to replace the advertisement with the another advertisement. A scene, comprising content associated with the advertisement, is retrieved. The content is replaced with alternate content associated with the another advertisement. The scene comprising the alternate content is stored.

### CROSS-REFERENCE TO RELATED APPLICATIONS

This application relates to U.S. application Ser. No. 10/020,779, filed Dec. 14, 2001, and incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the United States Patent and Trademark Office patent file or records, but otherwise reserves all copyright rights whatsoever.

### FIELD OF THE INVENTION

The present invention relates generally to the field of advertising, and more specifically, to advertising management systems and methods in which a new pricing methodology is employed whereby advertising and content categorized as override may be overridden by an advertiser desiring to pay a premium.

### BACKGROUND OF THE INVENTION

Advertisements, also referred to as commercials, are played in between subject portions of a television or radio program, and are the primary source of revenue for television and radio networks. Typically ten to ninety seconds in length, advertisements are grouped together as pre-selected breaks in the broadcast of a program, typically occurring from every few to every fifteen minutes of programming. The number of advertisements and the timing between the placement of the advertisements is dependent on the type of program (e.g., sporting event, sitcom, news program, or movie) and the format of the program (e.g., live or pre-recorded). Television and radio programming, for example, typically include approximately sixteen minutes of advertisements during every hour of programming. Many advertisers use this time as their primary avenue for promoting products, services, and events to consumers.

Advertising rates are generally based on the time slot, popularity of a program, and length of the advertisement. A higher rate is charged for a program with a large audience, due to the theory that more viewers, or listeners, will result in more potential customers receiving the advertisement, which is likely to result in more revenue generated for an advertiser. During the Super Bowl™, for example, a thirty second time spot may cost in the millions of dollars.

Advertisements are not limited to radio and television. In the age of computers, some form of advertisement is displayed on virtually every web-page. Conventional Internet advertising may also be in the form of “pop-up” windows, which are programmed to “pop-up” in their own separate window when a certain web-site is triggered, or opened. Many Internet service providers and search-engine companies are able to offer free services to consumers because of the large amounts of advertising dollars that they receive from advertisers. Like television and radio, the more popular a particular web-site is, the more that it is accessed by consumers, and the more the owner may charge for advertising space.

Advertising is generally more effective when products and services reach consumers that have an interest in the particular product or service. This is referred to as “targeted advertising,” in which an advertiser identifies a group of people as being those that are likely to purchase what is being advertised, and providing the most favorable situation in which the advertisement will reach that pre-determined group of consumers. As an example, it is generally known that a lot of men like sports. It is also generally known that a lot of men drink beer. Therefore, it makes economic sense for an advertiser to run a beer advertisement during sporting events, when it is more likely that men will be watching television. As stated above, advertisement time during the Super BOwl™ is very expensive, and although very expensive, it is common to see a large number of beer commercials during the Super Bowl™. This is normally because advertisers feel that the large premiums paid for time slots during the game will be made-up for by the amount of revenue that the commercial will generate for the company through beer sales.

In determining whether a program, or web-page, may be appropriate for a particular advertisement, advertisers typically consider whether the program attracts large numbers of viewers who are of the same age group, gender, income bracket, and who have similar interests and hobbies with those who are most likely to purchase the product being advertised. Selecting an advertisement and advertising slot in this manner, increases the likelihood that viewers who watch the advertisement will be interested viewers.

Broadcasting networks and advertisers are able to gauge which demographic groups are watching which programs using conventional market research tools. For example, the AC Nielsen™ ratings system tracks television viewing activities by sampling a plurality of households, and estimating the number of viewers of particular programs using the viewing activity data. Advertisers also use market research companies which conduct focus groups that study the effectiveness of different types of television advertisements. These market research tools assist advertisers in creating advertisements, and selecting appropriate time slots in which to run them. To help ensure that viewers watch a particular advertisement, advertisers use techniques that help to grab a viewers attention, such as visual stimulus, catchy slogans, and jingles.

To gauge the effectiveness of their spending, advertisers have long sought information related to potential consumer viewing patterns. There are several conventional devices and techniques that exist for gathering such information. For example, U.S. Pat. No. 4,258,386 issued to Cheung discloses “an apparatus for television audience analysis comprising means for monitoring a television receiver, means responsive to a monitored signal for storing information representative of channel identification and of the time at which a channel is selected and at which the selection of a channel is terminated, and means for reading the stored information periodically.”

As another example, U.S. Pat. No. 4,556,030 issued to Nickerson, et al., discloses “a data storage and transmission system for accumulating and transmitting data from a plurality of remote T.V. panelist locations to a central location. Each remote unit includes a microprocessor, a control memory, and a data store memory. The control memory stores control information for the remote unit, which may include dynamic allocation information. The data store memory is event driven and stores data as to television channel selection and times thereof, and can store viewer reaction data and the like. At a pre-selected time, each remote unit initiates a telephone call to a central location and identifies itself. Upon successful telephone connection between a remote unit and the central location, any data such as viewer habit and/or reaction data and the like contained in the data store memory is transmitted over the telephone line to the central location.”

Other conventional systems and methods provide somewhat more use data than only channel numbers viewed and the time of viewing, such as which products panelists purchase. U.S. Pat. No. 4,816,904 issued to McKenna, et al., discloses “a data gathering system including a plurality of remote units which are controlled from a central location. Each of the remote units are attached to a television receiver which is generally, but not necessarily, attached to a cable system. Each of the remote units may function to determine which of several TV modes is in use as well as to store TV channel selector data, data from an optical input device, and/or data input by viewers representative of the composition of the viewing audience. The data is stored for either later collection by a portable data collector, or for direct transmission via telephone to the central location. A video message for a TV viewer, such as a survey, may be transmitted from the central location and stored at the remote units, for later display on the TV receiver associated with the remote units. The substitution of alternate programming information may also be achieved by the central control point on selected of the remote units.”

Conventionally, panelist monitoring may be used to gauge the effectiveness of advertising on a selected group of panelists. Nevertheless, while panelist monitoring systems like those described above provide somewhat more monitoring data than just TV tuning data, they do so only for limited groups. For example, when more data is gathered (like purchase information), it is done only for the panelist groups, rather than for subscribers of the entire system.

Conventional systems typically capture ratings information that identifies which television shows are viewed, rather than whether the subscriber also viewed the commercials displayed during those shows. What is important to an advertiser is that potential consumers are interested in an advertisement enough to sit through its duration. There is a great deal of money invested in advertising, with the hopes that it will return even greater profits.

Conventional advertising management systems comprise what is generally referred to as a “locked” advertisement delivery system. In this conventional system, time slots are pre-purchased by advertisers. The rates for these time slots are based upon the demand for the particular time slot, as described above. When time slots are purchased, they are grouped together and run as a commercial break during a program, also as described above. When a time slot is purchased, it is no longer available to a second advertiser that may be interested in purchasing the same time slot, but who did not purchase it first. Conventional advertising management systems are basically first-come-first-serve. There may be bidding for a particular slot, but once a rate is agreed to by the advertising slot provider, that time slot is set.

Conventional advertising methods include several drawbacks, such as excluding potential consumers, and including viewers that have no desire to purchase the product or service. Advertisers must continuously evaluate advertising mediums and time slots. When selecting time slots, advertisers take into account which times of the day they are most likely to find large volumes of viewers, whether or not those viewers are of a desired demographic, and which programs are most appropriate to place advertisements into.

What is needed are novel systems and methods that result in more effectively spent advertising dollars for advertisers, which results in increased profit margins for the advertisers and also for network media providers. What is needed are novel systems and methods which result in flexibility and options for advertisers in selecting advertising time slots.

### BRIEF SUMMARY OF THE INVENTION

In a preferred embodiment, the present invention provides a pricing methodology whereby scheduled advertising content broadcast to potential consumers may be overridden and replaced by advertising content from an advertiser paying a premium. The method includes a first advertiser occupying an advertisement time slot with a first advertisement, categorizing the first advertisement as an overrideable advertisement or a non-overrideable advertisement, receiving a request from a second advertiser to replace the first advertisement with a second advertisement, and if it is determined that the first advertisement is categorized as an appropriate override advertisement, replacing the first advertisement with the second advertisement. The second advertisement is then broadcast to consumers in place of the first advertisement. Advertisements are broadcast to potential consumers via a broadcast transmission, wherein the broadcast transmission may include a television broadcast, a radio broadcast, and a broadcast sent over the Internet and received on a personal computer.

Various pricing structures may be employed. In one embodiment, the method further involves pricing an overrideable advertisement at a lower price than a non-overrideable advertisement, and wherein a premium is paid to replace the first advertisement with the second advertisement.

A request to replace the first advertisement with the second advertisement may be based upon data obtained using marketing tools and programming ratings collection and analysis systems to identify most-valuable and least-valuable viewers. The ratings collection and analysis systems may track program viewing activities by sampling a plurality of households and estimating the number of viewers of the programs using viewing activity data, focus groups that study the effectiveness of different types advertisements, and product sales reports.

In an alternative embodiment, the advertisement management method further includes receiving requests, and processing, storing, managing, and inserting advertisements using an interactive server. The interactive server compares the second and/or first advertisement with a plurality of pre-determined criteria, and if the advertisement meets a pre-selected number of the plurality of criteria, the interactive server may replace the first advertisement with the second advertisement.

In a further embodiment, the present invention provides a system for managing advertisement programming including a first advertisement provided by a first advertiser, a second advertisement provided by a second advertiser, and an interactive server of a network content provider, wherein the interactive server is operable for replacing the first advertisement with the second advertisement if a plurality of pre-determined criteria are met.

Embodiments of the present invention provide various advantages, such as novel advertisement pricing methodologies, advertisement time slot purchasing options, and targeted advertising methodologies. Embodiments of the present invention provide methods of effective advertising management and targeting that ensure that a particular demographic group receives the most appropriate materials.

A method is disclosed for replacing an advertisement. The advertisement is categorized as overrideable, wherein the advertisement may be replaced with another advertisement. A request is received to replace the advertisement with the another advertisement. A scene, comprising content associated with the advertisement, is retrieved. The content is replaced with alternate content associated with the another advertisement. The scene comprising the alternate content is stored.

A system is also disclosed for replacing an advertisement. The system is operative to categorize the advertisement as overrideable, wherein the advertisement may be replaced with another advertisement. A request is received to replace the advertisement with the another advertisement. A scene, comprising content associated with the advertisement, is retrieved. The content is replaced with alternate content associated with the another advertisement. The scene comprising the alternate content is stored.

A computer program product is also disclosed for replacing an advertisement. The computer program product includes processor-readable instructions to categorize the advertisement as overrideable, wherein the advertisement may be replaced with another advertisement. A request is received to replace the advertisement with the another advertisement. A scene, comprising content associated with the advertisement, is retrieved. The content is replaced with alternate content associated with the another advertisement. The scene comprising the alternate content is stored.

Additional objects, advantages, and novel features of the invention will be set forth in part in the description which follows, and in part will become more apparent to those skilled in the art upon examination of the following, or may be learned by practice of the invention.

### BRIEF DESCRIPTION OF THE DRAWINGS

These and other features, aspects, and advantages of the exemplary embodiments are better understood when the following Detailed Description is read with reference to the accompanying drawings, wherein:

FIG. 1 is a exemplary hardware environment of the present invention in which a network provider responds to a request from an advertiser using data obtained from an interactive server;

FIG. 2 is a functional block diagram illustrating one embodiment of the present invention in which an advertiser desiring to replace a scheduled advertisement contacts a network provider; and

FIG. 3 is a functional block diagram illustrating one embodiment of the present invention in which an advertiser desiring to replace a scheduled advertisement contacts a network provider and ultimately an interactive server,

FIG. 4 is a simplified schematic illustrating another exemplary operating environment;

FIG. 5 is a detailed schematic illustrating composition of scenes, according to more exemplary embodiments;

FIG. 6 is a flowchart illustrating a method for replacing advertisements, according to more exemplary embodiments;

FIG. 7 is a schematic illustrating a component table, according to still more exemplary embodiments; and

FIGS. 8-10 are flowcharts illustrating methods of replacing advertisements, according to even more exemplary embodiments.

### DETAILED DESCRIPTION OF THE INVENTION

As required, detailed embodiments of the present invention are disclosed herein, however, it is to be understood that the disclosed embodiments are merely exemplary of the invention that may be embodied in various and alternative forms. Specific structural and functional details disclosed herein are not to be interpreted as limiting, but merely as a basis for the claims as a representative basis for teaching one skilled in the art to variously employ the present invention. Conventional hardware and systems are shown in block diagram form and process steps are shown in flowcharts.

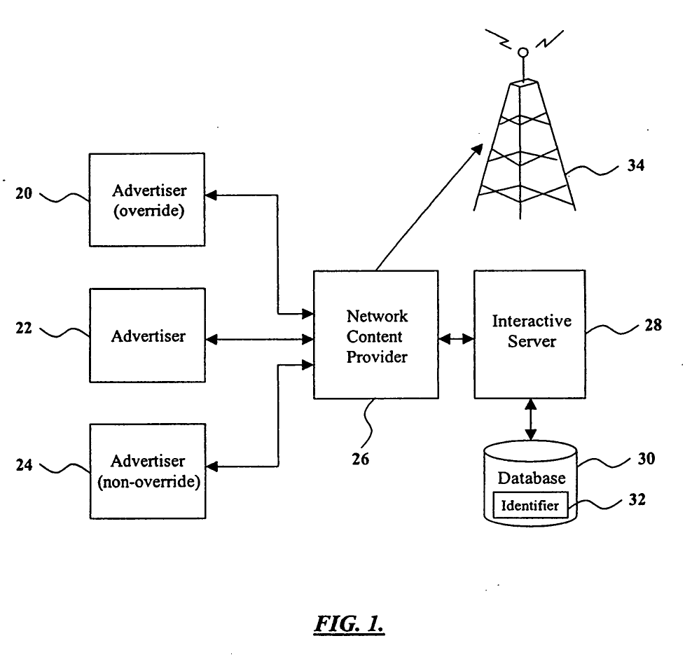

Referring now to the drawings, in which like numerals indicate like elements throughout the several figures, FIG. 1 illustrates an exemplary hardware environment in which programming content delivered in a scheduled lineup may be overridden by an advertiser desiring to pay a premium. FIG. 1 illustrates various system elements and subsystems that communicate with each other to transmit collected data information and data acknowledgments. The term scheduled is used herein to include the delivery of advertising and content whereby a fixed array of content programming is provided, and payments are made by advertising and content providers based upon that fixed array.

In one embodiment, a first advertiser 20 has a first advertisement already inserted into a scheduled broadcast to be transmitted in the future. The first advertisement has been categorized as an override advertisement, as discussed above. A second advertiser 22 has a second advertisement that is not yet inserted into any broadcast transmission, but desires to insert the second advertisement into the same broadcast transmission as the first advertiser 20. A third advertiser 24 has a third advertisement already inserted into the same broadcast transmission as the first advertiser 20. The third advertisement has been categorized as a non-override advertisement, as will be discussed below. All three advertisers 20, 22, 24 are in communication with a network content provider 26 that controls the broadcast and manages the advertisements.

The network content provider 26, responsible for providing a network service in which advertisements are broadcast to potential consumers, operates and maintains a system equipped to receive signals and other content from the advertisers 20, 22, 24. The network content provider 26 may be any original or secondary source of network programming including, for example, television, radio, Internet, or like digital environment. Content providers 26 may broadcast directly to potential consumers, or alternatively, may broadcast to a provider that receives and retransmits a broadcast to potential consumers. The advertisers 20, 22, 24 furnish content originated by them to the network content provider 26 that incorporates that content into the network content provider's 26 broadcast.

The system of FIG. 1 comprises an interactive server 28 operable for advertisement management. As is shown, the network content provider 26 and the advertisers 20, 22, 24 are connected to the interactive server 28 via the network content provider 26. The interactive server is capable of managing advertisements, receiving requests, checking a plurality of pre-determined criteria, and responding to the requests from the advertisers 20, 22, 24.

Signals containing requests and programming content furnished by the advertisers 20, 22, 24 are sent via suitable communication paths to content provider 26 and ultimately to the interactive server 28 comprising a processor for processing information. A provisioning technique available to an advertiser 22 with Internet access includes a Web-based form of entry of advertisement information. Using such a technique, an advertiser 22 using a browser running on a computer with an Internet connection accesses the interactive server and inputs requests and receives responses. Requests may include specific information relating to a particular advertisement or time slot, such as override and non-override categorization, and the override option. Advertisement schedules, characteristics, identifiers, and pricing may be stored in a database 30 of the interactive server 28. Each individual advertisement may have an associated identifier 32 that is used to identify the specific advertisement. The identifier 32 may include descriptive information such as the time length of the advertisement and file size. When a signal is received by the interactive server 28, the interactive server 28 identifies the selected advertisement and may insert it into a program time slot using if a series of checkpoints are completed and approved, as discussed above.

The network content provider 26 is able to insert the advertisement, identified by the interactive server 28 using its identifier, into the broadcast transmission 34. The primary functionality of the network content provider 26 is provided by the interactive server 28, which stores and manages the advertisements provided by the advertisers, and which responds to requests from the advertisers.

In one embodiment of the present invention, a provisioning method is provided in which an advertiser may access the interactive server 28 and override a prescheduled advertisement based on monitoring and marketing tools. The monitoring and marketing tools provide data to an advertiser which aid in selecting the most desirable time slot for each particular advertisement based on the data. Using data gathered regarding viewing habits, such as set top boxes use for monitoring viewing habits and collecting information, to distinguish more-valuable from less-valuable viewers, along with override and non-override categories, content and advertisements may be matched with more-valuable and less-valuable viewer subsets.

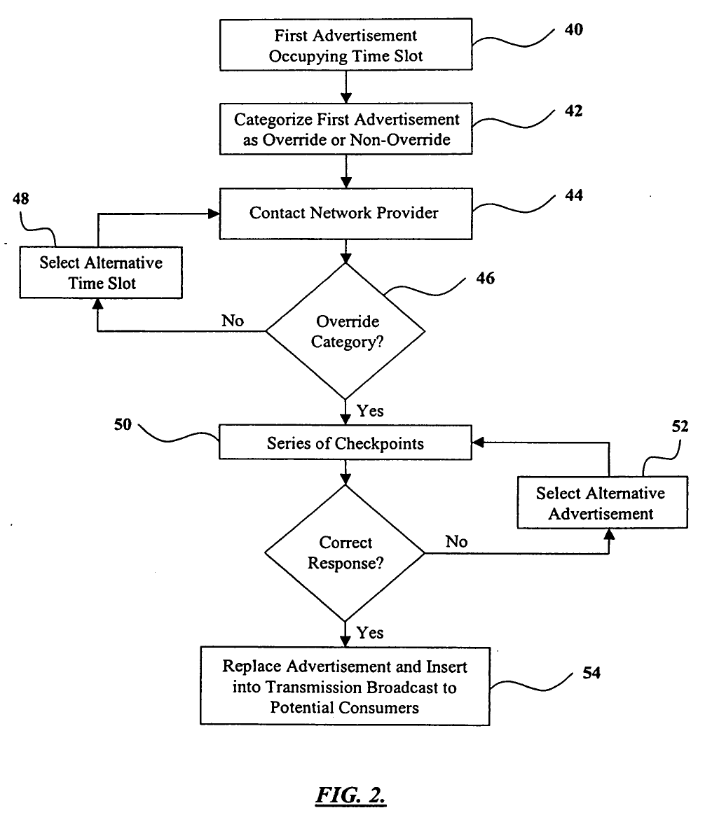

FIG. 2 illustrates a preferred embodiment of an advertising management method in which an advertiser, by paying a premium, may replace a scheduled advertisement with a different advertisement. The method includes a first advertiser having a first advertisement that is scheduled to be broadcast at some time in the future (Block 40). The first advertisement may be part of a group of advertisements which are shown at pre-determined times during a subject program. Typically, one hour of programming usually includes about sixteen minutes of advertising. Each advertisement corresponds with a time slot, and time slots are grouped together to form a commercial break in the programming schedule.

The present invention establishes a pricing methodology whereby an advertisement categorized as override may be overridden, or replaced. When providing an advertisement to a network provider for broadcast, an advertiser has the option of categorizing the advertisement as either an override or a non-override advertisement (Block 42), and paying a corresponding fee based on the category chosen. In an alternative embodiment, a network provider may offer time slots that are pre-categorized as either override or non-override, and an advertiser may purchase a time slot based upon the desired category. Overrideable is hereby defined as capable of being replaced. Non-override is hereby defined as not capable of being replaced. An overrideable advertisement is an advertisement that may be broadcast, or, may be replaced by a different advertisement, either from the same or a different advertiser. A non-overrideable advertisement is an advertisement that will be broadcast, and is not capable of being replaced.

In the preferred embodiment, an advertisement, or time slot, categorized as override is priced at a lower cost than an advertisement, or time slot, categorized as non-override, for the reason that an override advertisement may not be broadcast if replaced. An advertiser may opt to purchase this advertising option due to its lower price. An advertiser may also opt to purchase the option based upon information that may lead the advertiser to believe that their advertisement will most likely not be overridden. The information may include such items as the time of day, the day of the week, the program that the advertisement will be shown during, time slot demand, marketing tools, and previous advertiser replacements. For example, if an advertiser has a limited advertising budget, the advertiser may opt to categorize his/her advertisement as an override advertisement based upon time slot demand and the past history of replacements made during the desired time slot. In another example, if an advertiser has a very limited potential consumer audience that also coincides with a low-demand time slot, the advertiser may choose the lower priced overrideable option to save money.

In the preferred embodiment, an advertisement, or time slot, categorized as non-override is priced at a higher cost than an advertisement, or time slot, categorized as override, for the reason that a non-override advertisement will be broadcast and can not be replaced. An advertiser may opt to purchase this advertising option due to demand and projected audience value. An advertiser may also opt to purchase the option based upon information that may lead the advertiser to believe that the greater cost will lead to greater revenues. The information may include such items as the time of day, the day of the week, the program that the advertisement will be shown during, time slot demand, marketing tools, and previous advertiser replacements.

In the preferred embodiment, an advertiser wishing to override the first advertisement with the second advertisement may be required to pay a premium. The amount of the premium may vary based upon the time slot desired and the characteristics and content of the subject matter surrounding the commercial break. For example, desired override advertising time during a live one-time championship sporting event may be priced at a much higher amount than override advertising time during a regularly scheduled program due to the special nature of the program.

Network providers, such as television and radio, sell advertising space based on the length of time of an advertisement, the day of the week, the time of day, advertiser demand, and the type of program the advertisement will be played during. Most television viewers watch television during the prime-time viewing hours of about 7 pm to about 10 pm, and network providers, therefore, charge higher rates during these viewing hours due to advertiser demand. Internet network providers may sell advertising time based on file size and type, and may also set fees based on the time of day, the day of the week, and specific programs.

Content delivered to a network content provider by an advertiser includes advertisements relating to products, services, and events. The advertisements, in one example referred to as commercials, are played in between the subject potions of the network content providers program. Referring to television and radio broadcasts, advertisements range from about ten to about ninety seconds in length, and are grouped together as pre-selected breaks in the broadcast of the program, occurring every few minutes of programming. The number of advertisements and the timing between the placement of the advertisements is dependent upon the type of program (e.g., sporting event, sitcom, news program, or movie) and the format of the program (e.g., live or pre-recorded). Television and radio programming, for example, typically include approximately sixteen minutes of advertisements during every hour of programming.

The method further includes a second advertiser, having a second advertisement, desiring the time slot occupied by the already scheduled first advertisement. The second advertiser then contacts the appropriate network provider that is in charge of the scheduling of the desired time slot, to inquire about overriding the first advertisement and replacing it with the second advertisement (Block 44). As stated above, only an advertisement categorized as override is capable of being overridden. The network provider then informs the second advertiser of the category of the first advertisement or time slot (Block 46).

The network content provider (26, FIG. 1) checks the first advertisements category and may determine that the first advertisement is an override advertisement, in which case the second advertiser has the option of overriding, or replacing the first advertisement with a second different advertisement. The network content provider 26 may determine that the first advertisement is a non-override advertisement, in which case the second advertiser is not able to replace the first advertisement and must either choose a new first advertisement or time slot (Block 48), or opt not to proceed.

After the network content provider (26, FIG. 1) determines that the first advertisement is capable of being overridden, the network provider 26 goes through a series of checkpoints (Block 50) to determine if the second advertisement may be inserted into the broadcast in the place of the first advertisement. A correct response to the series of checkpoints will lead to the replacement of the first advertisement with the second advertisement (Block 54). An incorrect response to the series of checkpoints leads to the advertiser having to choose an alternative second advertisement to be inserted (Block 52), or opting not to proceed.

The series of checkpoints may include the first and second advertisements lengths in time, the proper fees, technical specifications, and a search to determine when the last time that an advertisement was broadcast relating to the same or similar type product. The time length requirement is to ensure that the second advertisement is an appropriate fit and will not result in a disruption in the broadcast transmission. The proper fees checkpoint is to ensure that a premium has been paid, or will be paid, by the advertiser to override the first advertisement. Technical specifications may include such items as formatting and an appropriate amount of time necessary to implement the change without a causing a disruption in the broadcast transmission. Other technical specifications will be well-known to those of ordinary skill in the art.

To illustrate the series of checkpoints, for example, assume that an advertiser of a sport-utility automobile desires to replace a first sport-utility automobile advertisement, of a competitor, with a second advertisement. The advertisement substitution may involve the network content provider (26, FIG. 1) and ultimately the interactive server (28, FIG. 1) running through a series of checkpoints to determine if a substitution is possible and appropriate. The series may involve verifying that the first advertisement is indeed an advertisement categorized as overrideable. Once verified, the network provider 26 may then determine whether the second advertisement possesses the required characteristics in order to replace the first advertisement, such as equal or near in length time lengths and whether the second advertisement has been recorded in a compatible format with the scheduled broadcast. A further checkpoint may include a search by the network provider 26 or interactive server 28 to determine when the last time an advertisement was broadcast relating to a sport-utility vehicle, or any vehicle, either by the same or different advertiser. The network provider 26 may opt not to replace the first advertisement if the second advertiser had a similar advertisement run in the recent past, such as a term of a few hours.

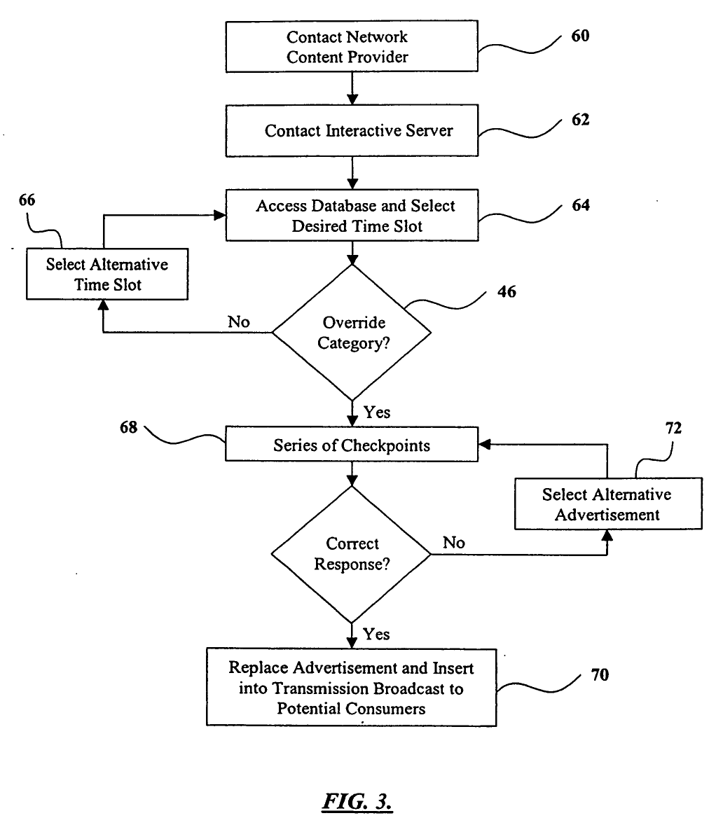

Referring to FIG. 3, in an alternative embodiment, the pricing methodology discussed above may include the interactive server (28, FIG. 1) operable for advertisement management. The method includes a first advertiser having a first advertisement already inserted into a scheduled broadcast that will be transmitted in the future (Block 40, FIG. 2). The second advertiser having a second advertisement desires the specific time slot occupied by the first advertisement. The second advertiser first contacts the network content provider (Block 60) and ultimately the interactive server 28 of the network content provider (Block 62).

The interactive server 28 receives a request from the second advertiser 22 regarding specifications and override options relating to the first advertisement. The interactive server 28 accesses and retrieves information from the database (Block 64). As stated above, only an advertisement categorized as override is capable of being overridden. The interactive server 28 transmits the requested information to the second advertiser regarding the first advertisement, information including categorization.

The network content provider (26, FIG. 1) checks the first advertisements category (Block 46, FIG. 2) and may determine that the first advertisement is an override advertisement, in which case the second advertiser has the option of overriding, or replacing the first advertisement with a second different advertisement. The network content provider 26 may determine that the first advertisement is a non-override advertisement, in which case the second advertiser is not able to replace the first advertisement and must either choose a new first advertisement or time slot (Block 66), or opt not to proceed.

After the interactive server 28 determines that the first advertisement is capable of being overridden, the interactive server 28 runs through a series of checkpoints (Block 68) to determine if the second advertisement may be inserted into the broadcast in the place of the first advertisement. A correct response to the series of checkpoints will lead to the replacement of the first advertisement with the second advertisement (Block 70). An incorrect response to the series of checkpoints leads to the advertiser having to choose an alternative second advertisement to be inserted (Block 72), or opting not to proceed.

As stated above, the series of checkpoints may include the first and second advertisements lengths in time, the proper fees, technical specifications, and a search to determine when the last time that an advertisement was broadcast relating to the same or similar type product. The time length requirement is to ensure that the second advertisement is an appropriate fit and will not result in a disruption in the broadcast transmission. The proper fees checkpoint is to ensure that a premium has been paid, or will be paid, by the advertiser to override the first advertisement. Technical specifications may include such items as formatting and an appropriate amount of time necessary to implement the change without a causing a disruption in the broadcast transmission. Other technical specifications will be well-known to those of ordinary skill in the art.

In one embodiment, the present invention may acquire data used to select a desired advertising time slot based on a demographics and programming ratings collection and analysis system, as is well known in the art. The ratings collection and analysis systems may track program viewing activities by sampling a plurality of households and estimating the number of viewers of the programs using viewing activity data, focus groups that study the effectiveness of different types advertisements, and product sales reports. Using data gathering technology to identify valuable viewers, override and non-override advertisements may be matched to correspond with most-valuable and least-valuable viewer subsets. In one embodiment, a processor determines valuable viewer subsets by collecting information to create a log about all events or selected events of interest viewed by potential consumers. Other marketing tools may be used to determine valuable viewer subsets, and the information obtained using these marketing tools may aid an advertiser in making decisions regarding when to override a scheduled advertisement.

The systems and methods of the present invention may be employed for use Internet advertising management. In one embodiment, an Internet network content provider may provide advertisements displayed as “pop-up” web-pages. A scheduled programmed first “pop-up” advertisement may be replaced by a second advertisement in a similar manner as described above. Alternative embodiments may include replaceable advertisements displayed on a web-page containing additional content unrelated to the product or service being displayed.

The systems and methods of the present invention may be employed for use in radio broadcasts. A scheduled first advertisement may be replaced by a second advertisement in a commercial break broadcast during a radio program, using the pricing methodology described above. In alternative embodiments, the systems and methods of the present invention may be employed in any additional field in which advertisements are broadcast to viewers.

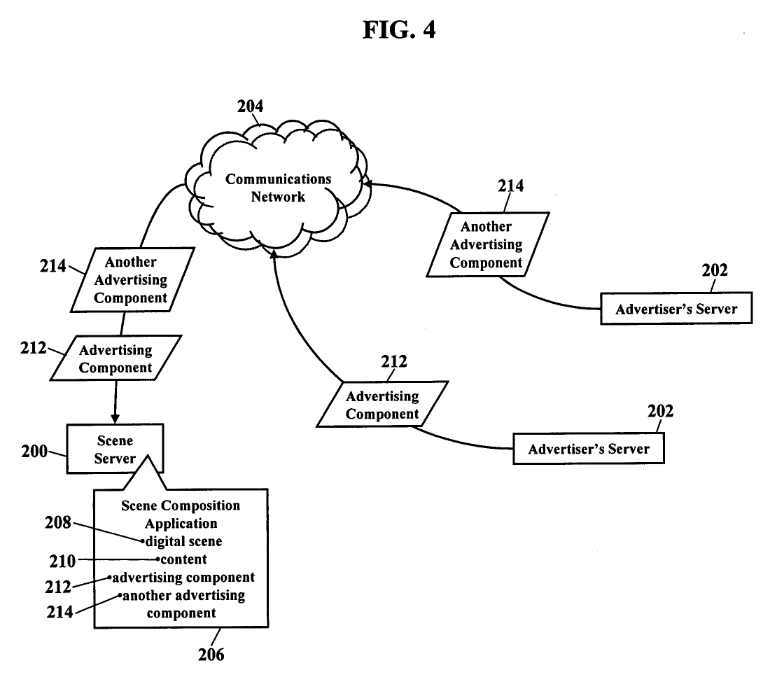

FIG. 4 is a simplified schematic illustrating another exemplary operating environment. Here a scene server 200 communicates with multiple advertisers' servers 202 via a communications network 204. The scene server 200 stores and executes a scene composition application 206. The scene composition application 206 constructs, assembles, or otherwise composes a digital scene 208 using one or more individual pieces of content 210. The content 210 may be any data, metadata, object, digital item, or mask that may be inserted into, and/or overlayed onto, the digital scene 208. Once the digital scene 208 is composed from the individual content 210, the scene 208 may then be sequenced into a multimedia product (such as a movie, webpage, or any other multimedia offering). The scene 208 is thus a composition of the individual pieces of content 210, and any of the content 210 may include an advertisement associated with any of the advertisers' servers 202. The advertisement is an advertising component 212 of the scene 208.

Advertisers may compete within the scene 208. Because the scene 208 is a composition of content 210, advertisers may vie to have their products and/or services featured in the scene 208. As the above paragraphs explained, if an advertising component 210 is categorized as overrideable, then the advertising component 212 may be replaced by another advertiser's component 214. Suppose the scene 208 has a lead male character. The lead male wears a baseball hat and holds a generically-labeled bottle. One advertiser may vie to have the bottle be a nationally-recognized bottle of cola, while another advertiser would prefer that the leading male hold a nationally-recognized bottle of beer. Similarly, advertisers' may compete to have their logos/trademarks inserted onto the hat's bill or crown. Because the scene 208 is composed of disparate digital items, however, the generically-labeled bottle may be easily replaced with an advertiser's corresponding digital item. That is, the content item representing the generically-labeled bottle may be removed from the scene 208 and replaced with an advertiser's corresponding digital item. Similarly, logos/trademarks may be swapped on the hat when desired. The scene 208 is thus composed of digital subcomponents that may be interchanged and easily instantiated when needed. Even larger content items, such as a designer's clothing or a manufacturer's car, may be replaced by another designer's clothing or another manufacturer's car. Because the advertising content 210 may be categorized as overrideable, then the advertising content 210 may be replaced by other advertising content 210.

Exemplary embodiments are applicable to any content within the scene 208. That is, any content 210 that is a component of the scene 208 may be categorized as overrideable or non-overrideable. Individual pieces of content 210 that are categorized as non-overrideable may not be removed from the scene 208. Pieces of content 210 that are categorized as overrideable, however, may be removed from the scene 208. Yet exemplary embodiments are mostly described in the context of overrideable and non-overrideable advertising content, thus allowing one advertiser's advertisement or product placement to be replaced by another advertiser's content.

The MPEG standards may be used to configure the scene 208. When the scene's component content 210 adhere to the MPEG standards, each individual piece of content 210 may include descriptive elements that describe how each item of content 210 is assembled within the scene 208. Each digital item, object, or content may thus be handled and manipulated independent of any surrounding objects and any background objects. Any content 210 within in the scene 208 may also be scaled, extracted, and/or edited using these same standards. Because, however, the MPEG standards are already known to those of ordinary skill in the art, these standards need not be described in detail. If, however, the reader desires a more detailed explanation of these standards, the reader is invited to consult the MPEG-4, MPEG-7, and MPEG-21 standards, available from the International Organization for Standardization (ISO) 1, rue de Varembé, Case postale 56 CH-1211 Geneva 20, Switzerland, and incorporated herein by reference in their entirety.

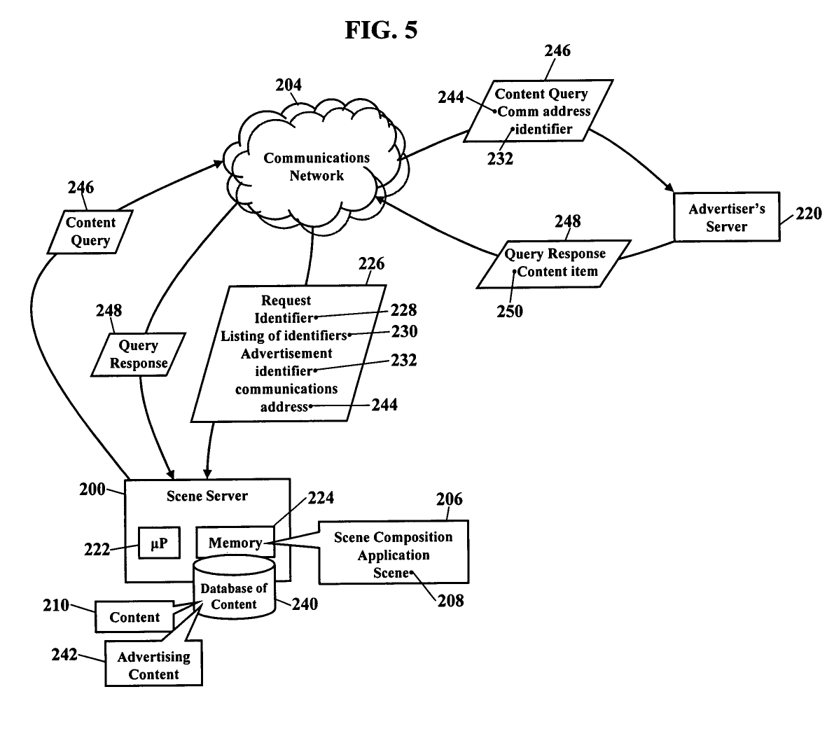

FIG. 5 is a detailed schematic illustrating composition of scenes, according to more exemplary embodiments. FIG. 5, for simplicity, only illustrates a single advertiser's server 220 that communicates with the scene server 200. Each of the multiple advertisers' servers (shown as reference numeral 202 in FIG. 4) may, however, use similar communications when vying to have their advertisements inserted into scenes. The scene server 200 has a processor 222 (e.g., “μP”), application specific integrated circuit (ASIC), or other similar device that executes the scene composition application 206 stored in memory 224. The scene composition application 206 comprises processor-executable instructions that compose or assemble scenes from content items. As FIG. 5 illustrates, the scene server 200 receives a request 226 to compose a scene. Because the request 226 may originate from any source or device, FIG. 5 simply illustrates the request 226 being received from the communications network 204. The request 226 comprises at least one identifier 228 of a content item that is used to compose the requested scene. More likely the request 226 would include a listing 230 of identifiers from which the requested scene is composed. Each identifier 226 is a unique alphanumeric label, filename, or header that is associated with the corresponding content. The listing 230 of identifiers may include an advertisement identifier 232. The advertisement identifier 232 uniquely identifies an advertising content item from which the requested scene is orchestrated.

The scene composition application 206 orchestrates the requested scene. The scene composition application 206 extracts, obtains, or retrieves the listing 230 of identifiers. The scene composition application 206 may then query a database 240 of content. The database 240 of content is illustrated as being locally stored in the memory 224 of the scene server 230, yet the database 240 of content may be remotely accessible via the communications network 204. The database 240 of content stores content items from which the requested scene is composed. The scene composition application 206 queries the database 240 of content for each identifier 228 in the listing 230 of identifiers. The scene composition application 206 thus retrieves each item of the content 210 associated with the listing 230 of identifiers, including advertising content 242 associated with the advertisement identifier 232. The scene composition application 206 then composes the requested scene 208 from the retrieved content items. The requested scene 208 is then stored in the memory 224.

The scene composition application 206 may query the advertiser's server 220. Sometimes the database 240 of content may not store content associated with one or more of the identifiers 228. Other times an identifier 228 may include a communications address 244 from which the content may be obtained. The scene composition application 206 may then instruct the processor 222 to send a content query 246 to the communications address 244. The content query 246 includes at least one identifier 228 from the listing 230 of identifiers for remotely-accessible content from which the request scene is composed. In FIG. 5 the communications address 244 corresponds to the advertiser's server 220, and the advertiser's server 220 thus stores content on behalf of the advertiser. The advertiser's server 220 retrieves the queried content and returns a query response 248. The query response xx comprises the remotely-accessible content item 250. The scene composition application 206 thus retrieves the remotely-accessible content item 250, composes the requested scene 208, and stores the requested scene 208 in the memory 224.

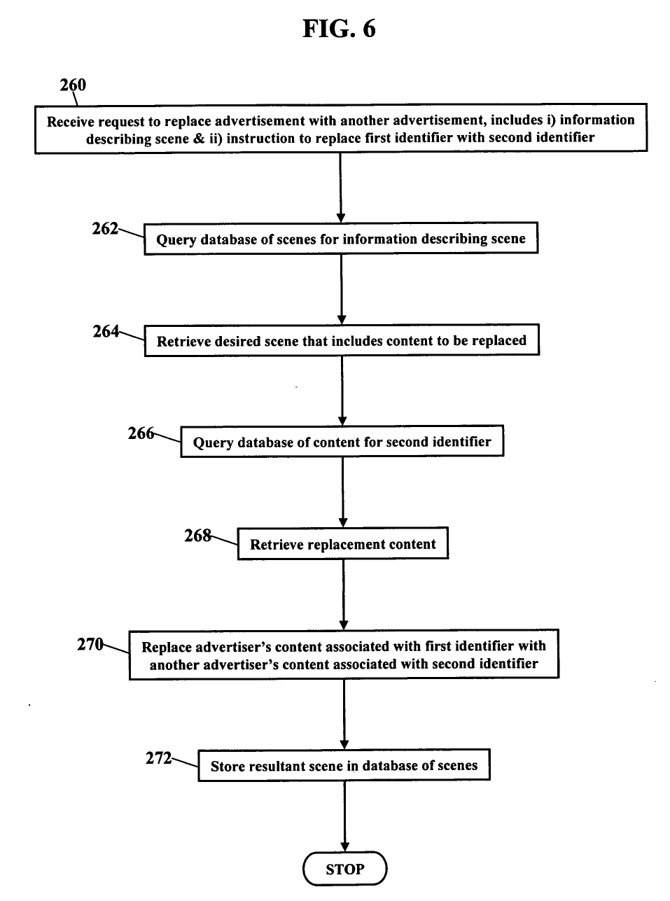

FIG. 6 is a flowchart illustrating a method for replacing advertisements, according to more exemplary embodiments. A request to replace an advertisement with another advertisement is received (Block 260). The request includes information that describes the scene and an instruction to replace a first identifier with a second identifier. A database of scenes is queried for the information that describes the scene (Block 262). The database of scenes stores assembled scenes that are available for sequencing into movies, web pages, and any other multimedia products. The desired scene is retrieved that includes the content to be replaced (Block 264). A database of content is queried for the second identifier (Block 266), and the replacement content is retrieved (Block 268). The advertiser's content (associated with the first identifier) is replaced with the another advertiser's content (associated with the second identifier) (Block 270). The resultant scene is stored in the database of scenes (Block 272). The resultant scene is thus ready for sequencing in, or insertion into, any digital multimedia product.

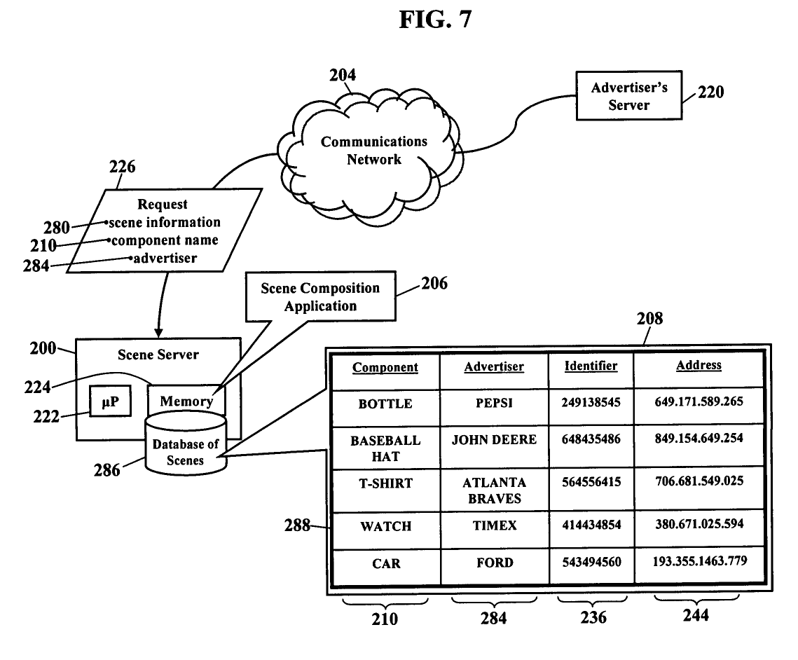

FIG. 7 is a schematic illustrating a component table, according to still more exemplary embodiments. Here the scene 208 is choreographed from multiple advertisers' content, and the scene 208 may described by its component content. The scene composition application 206 again receives the request 226 to replace advertising content. The request 226 includes scene information 280 that describes the scene, and the request 226 may include a component name 210 associated with an advertiser 284. When the scene composition application 206 receives the request 226, the scene composition application 206 queries a database 286 of scenes for the scene information 280 describing the scene. The database 286 of scenes is again illustrated as being locally stored in the memory 224 of the scene server 200, yet the database 286 of scenes may be remotely accessible via the communications network 204. The database 286 of scenes returns the requested scene 208 associated with the scene information 280. FIG. 7 illustrates the scene 208 as a component table 288 that maps, relates, or otherwise associates the scene's component content 210. The database 286 of scenes, for example, stores all the component parts 210 to the scene 208. FIG. 7 only illustrates overrideable advertising content 210, along with the currently-assigned advertiser's name 292 and the identifier 228 that corresponds to the advertiser's content. Although not shown, the component table 288 may also store non-overrideable content, such as advertisers who have paid a premium (as discussed in earlier paragraphs). The component table 288 could also store background and other content that would not normally be replaced within the scene 208. The component table 288 thus allows the scene composition application 206 to at any time retrieve what advertiser 284 is associated with the scene's component 200.

An example helps explain the component table 288. Suppose again that the lead male in the scene is wearing a baseball hat and holding a generically-labeled bottle. The leading male is also wearing a t-shirt, and a watch is around his wrist. The leading male is also sitting in a car. As FIG. 7 illustrates, the component table 288 lists each advertiser 284 that is associated with the scene's component parts 210. The component “BOTTLE,” for example, may be associated with PEPSI®. The “BASEBALL HAT” is currently associated with JOHN DEERE®, the “T-SHIRT” is associated with ATLANTA BRAVES®, the “WATCH” is associated with TIMEX®, and the “CAR” is associated with FORD®. The component table 288 thus identifies each advertiser, and each advertiser's content identifier 228, associated with the scene's components 210. The component table 288 may even associate the communications address 244 from which an advertiser's content may be remotely retrieved.

The scene is thus an orchestration of sub-components. The component table 288 lists the component parts that will be assembled to create the scene. Some components may be retrieved from the database 240 of content (e.g., locally stored in the memory 224 of the scene server 200). Other components may be remotely retrieved via the communications network 204. Some components may even be retrieved from the advertiser's server 220. When some instantiation time arrives, the scene composition application 206 assembles the disparate component parts 210 into the resultant scene 208. The component parts 210 interact within the scene's coordinate system, regardless of each component's formatting or complexity. That is, the component parts 210 may range from primitive still images or text, to moderately complex audio objects, to intricate/complex video objects. When the component parts 210 adhere to the MPEG standards, each component 210 may also include descriptive elements that describe how each item of content is assembled within the scene. Once the scene 208 is orchestrated, the 208 scene may then be saved in the database 286 of scenes.

Exemplary embodiments may be applied to in a more granular fashion. The above paragraphs explained how a scene is orchestrated from the disparate component parts 210. Each component part 210 is an individual media object, digital item, or other sub-component file. Yet exemplary embodiments may be applied to even smaller components, such as individual pixels. Each individual pixel may be considered a component of the scene. Each pixel may be categorized as overrideable or non-overrideable. A non-overrideable pixel may not be changed (or “removed”), while an overrideable pixel may be removed. Higher-resolution scenes may have more pixels from which to categorize. An overrideable pixel may have any of its properties changed (e.g., red, green, or blue). A non-overrideable pixel may have its properties fixed.

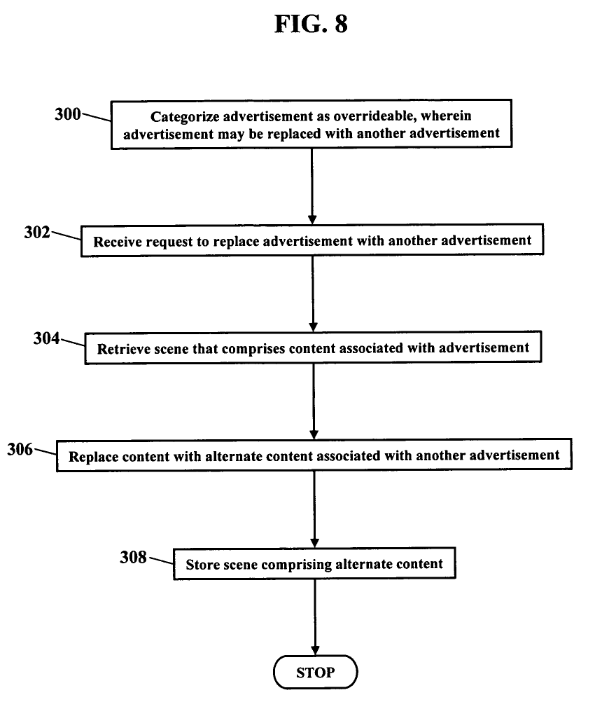

FIG. 8 is a flowchart illustrating a method of replacing an advertisement, according to even more exemplary embodiments. The advertisement may be categorized as overrideable, wherein the advertisement may be replaced with another advertisement (Block 300). A request is received to replace the advertisement with the another advertisement (Block 302). A scene is retrieved that comprises content associated with the advertisement (Block 304). The content is replaced with alternate content associated with the another advertisement (Block 306). The scene comprising the alternate content is stored (Block 308).

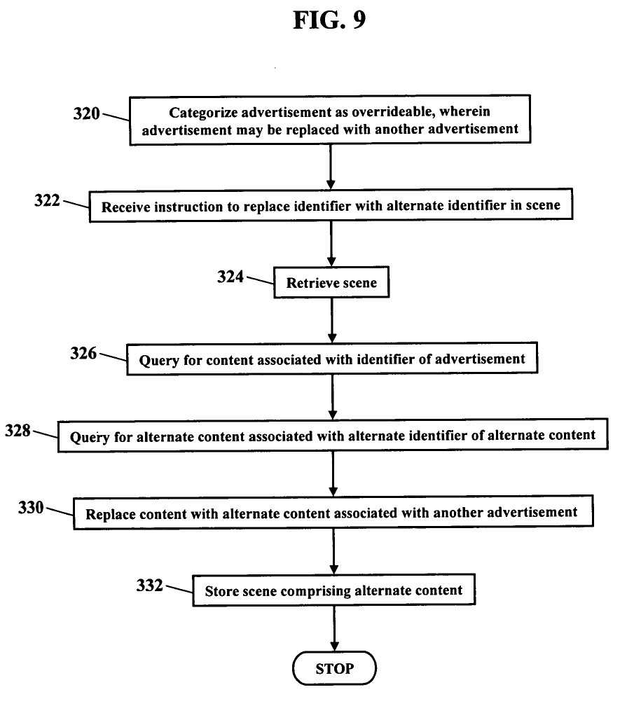

FIG. 9 is a flowchart illustrating another method of replacing an advertisement, according to still more exemplary embodiments. The advertisement may be categorized as overrideable, wherein the advertisement may be replaced with another advertisement (Block 320). An instruction is received to replace an identifier with an alternate identifier in a scene (Block 322). The scene is retrieved (Block 324). A query is made for content associated with the identifier of the advertisement (Block 326). Another query is made for alternate content associated with the alternate identifier of the alternate content (Block 328). The content is replaced with the alternate content associated with the another advertisement (Block 330). The scene comprising the alternate content is stored (Block 332).

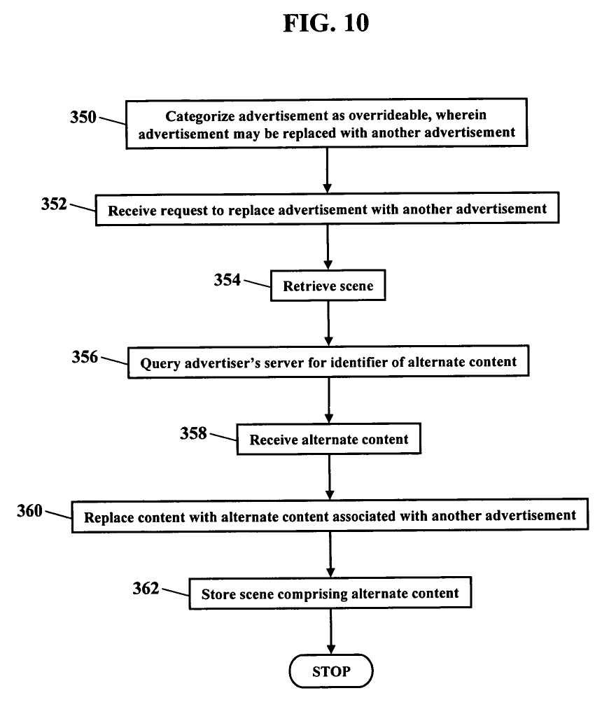

FIG. 10 is a flowchart illustrating yet another method of replacing an advertisement, according to more exemplary embodiments. The advertisement may be categorized as overrideable, wherein the advertisement may be replaced with another advertisement (Block 350). A request is received to replace the advertisement with the another advertisement (Block 352). A scene is retrieved (Block 354). An advertiser's server is queried for an identifier of the alternate content (Block 356), and the alternate content is received in response to the query (Block 358). The content is replaced with alternate content associated with the another advertisement (Block 360). The scene comprising the alternate content is stored (Block 362).

Exemplary embodiments may be physically embodied on or in a computer-readable medium. This computer-readable medium may include CD-ROM, DVD, tape, cassette, floppy disk, memory card, and large-capacity disk (such as IOMEGA®, ZIP®, JAZZ®, and other large-capacity memory products (IOMEGA®, ZIP®, and JAZZ® are registered trademarks of Iomega Corporation, 1821 W. Iomega Way, Roy, Utah 84067, 801.332.1000, www.iomega.com). This computer-readable medium, or media, could be distributed to end-subscribers, licensees, and assignees. These types of computer-readable media, and other types not mention here but considered within the scope of the exemplary embodiments. A computer program product comprises processor-executable instructions for replacing advertisements.

The foregoing is provided to explain and disclose preferred embodiments of the present invention, modifications to which may be made that still fall within the following claims. For instance, the architecture and programming of the system may be modified. Or, a variety of different manufacturers' servers or databases may be configured in order to implement the system. Further modifications and adaptations to the described embodiments will be apparent to those skilled in the art and may be made without departing from the scope or spirit of the invention and the following claims.

What is claimed is:

1. A processor-implemented method of replacing an advertisement, comprising:
categorizing the advertisement as overrideable, wherein the advertisement may be replaced with another advertisement;
receiving a request to replace the advertisement with the another advertisement;
retrieving a scene comprising content associated with the advertisement;
replacing the content with alternate content associated with the another advertisement; and
storing the scene comprising the alternate content.

2. The method of claim 1, further comprising querying for an identifier of the content associated with the advertisement.

3. The method of claim 2, further comprising querying for an alternate identifier associated with the alternate content.

4. The method of claim 3, wherein receiving the request comprises receiving an instruction to replace the identifier with the alternate identifier.

5. The method of claim 1, wherein replacing the content comprises replacing a digital item with an alternate digital item, the digital item associated with the content and the alternate digital item associated with the alternate content.

6. The method of claim 1, wherein replacing the content comprises replacing an object with an alternate object, the object associated with the content and the alternate object associated with the alternate content.

7. The method of claim 1, further comprising i) querying an advertiser's server for an identifier of the alternate content, and ii) receiving the alternate content in response to the query.

8. A system for replacing an advertisement, the system operative to:
categorize the advertisement as overrideable, wherein the advertisement may be replaced with another advertisement;
receive a request to replace the advertisement with the another advertisement;
retrieve a scene comprising content associated with the advertisement;
replace the content with alternate content associated with the another advertisement; and
store the scene comprising the alternate content.

9. The system of claim 8, further operative to query for an identifier of the content associated with the advertisement.

10. The system of claim 9, further operative to query for an alternate identifier associated with the alternate content.

11. The system of claim 10, further operative to receive an instruction to replace the identifier with the alternate identifier.

12. The system of claim 8, further operative to replace a digital item with an alternate digital item, the digital item associated with the content and the alternate digital item associated with the alternate content.

13. The system of claim 8, further operative to replace an object with an alternate object, the object associated with the content and the alternate object associated with the alternate content.

14. The system of claim 8, further operative to receive a request to compose the scene using an identifier of the content associated with the advertisement.

15. A computer program product storing processor-readable instructions for:
categorizing an advertisement as overrideable, wherein the advertisement may be replaced with another advertisement;
receiving a request to replace the advertisement with the another advertisement;
retrieving a scene comprising content associated with the advertisement;
replacing the content with alternate content associated with the another advertisement; and
storing the scene comprising the alternate content.

16. The computer program product of claim 15, further comprising instructions for querying for an identifier of the content associated with the advertisement.

17. The computer program product of claim 16, further comprising instructions for querying for an alternate identifier associated with the alternate content.

18. The computer program product of claim 17, further comprising instructions for receiving an instruction to replace the identifier with the alternate identifier.

19. The computer program product of claim 15, further comprising instructions for replacing a digital item with an alternate digital item, the digital item associated with the content and the alternate digital item associated with the alternate content.

20. The computer program product of claim 15, further comprising instructions for replacing an object with an alternate object, the object associated with the content and the alternate object associated with the alternate content.
